(19) United States
(12) Patent Application Publication
(10) Pub. No.: US 2023/0217269 A1
(43) Pub. Date: Jul. 6, 2023

(54) Verifying Availability of at Least Part of a Communication Link

(71) Applicant: Telefonaktiebolaget LM Ericsson (publ), Stockholm (SE)

(72) Inventor: Kurt Essigmann, Aachen (DE)

(21) Appl. No.: 17/928,769

(22) PCT Filed: Jun. 4, 2020
(86) PCT No.: PCT/EP2020/065550

§ 371 Date: Nov. 30, 2022

(51) Int. Cl. H04W 24/00; H04W 76/50; H04W 76/12

(52) U.S. Cl. CPC H04W 24/00; H04W 76/50; H04W 76/12

(57) ABSTRACT

Methods and apparatus are provided. In an example aspect, a method in a first network node for verifying availability of at least part of a communication link is provided. The method comprises receiving, from a first functional safety application, a plurality of first messages for verifying availability of a communication link between the first functional safety application and a second functional safety application according to one or more parameters associated with the communication link, wherein each first message includes one or more respective data. The method also comprises exchanging, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include.

### TECHNICAL FIELD

Examples of the present disclosure relate to verifying availability of at least part of a communication link, for example where the communication link is between a first functional safety application and a second functional safety application.

### BACKGROUND

Functional safety applications are software applications that provide or assist with functional safety. Functional safety refers to the safety of a system, such as an industrial system, and devices that provide functional safety may include protection systems such as emergency stop buttons and optical safety curtains around dangerous machinery.

Functional safety applications use a communication network as a ‘black channel’. That is, the message transfer reliability in the communication network as well as the communications channel availability itself is considered as unreliable. Therefore, a safety application will supervise the communication channel to guarantee the needed reliability. Supervision is done using application-level messages which are sent to and acknowledged by another safety application, where the two safety applications are end points of the communication link between the two applications. The application-level messages for supervision may be referred to as watchdog messages.

Communication networks that themselves guarantee a certain reliability can be used as ‘white channel’, i.e. no channel supervision is applied by the functional safety application. A wireless communication network such as a 3GPP-based communication network is considered to be and used as a ‘black channel’.

### SUMMARY

One aspect of the present disclosure provides a method in a first network node for verifying availability of at least part of a communication link. The method comprises receiving, from a first functional safety application, a plurality of first messages for verifying availability of a communication link between the first functional safety application and a second functional safety application according to one or more parameters associated with the communication link, wherein each first message includes one or more respective data. The method also comprises exchanging, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

A further aspect of the present disclosure provides method in a first network node for verifying availability of at least part of a communication link. The method comprises generating and sending, to a first functional safety application, a plurality of first messages for verifying availability of a communication link between the first functional safety application and a second functional safety application according to one or more parameters associated with the communication link, each first message includes one or more respective data. The method also comprises exchanging, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

An additional aspect of the present disclosure provides apparatus in a first network node for verifying availability of at least part of a communication link. The apparatus comprises a processor and a memory. The memory contains instructions executable by the processor such that the apparatus is operable to receive, from a first functional safety application, a plurality of first messages for verifying availability of a communication link between the first functional safety application and a second functional safety application according to one or more parameters associated with the communication link, wherein each first message includes one or more respective data; and exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

Another aspect of the present disclosure provides apparatus in a first network node for verifying availability of at least part of a communication link. The apparatus comprises a processor and a memory. The memory contains instructions executable by the processor such that the apparatus is operable to generate and send, to a first functional safety application, a plurality of first messages for verifying availability of a communication link between the first functional safety application and a second functional safety application according to one or more parameters associated with the communication link, each first message includes one or more respective data; and exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

A further aspect of the present disclosure provides apparatus in a first network node for verifying availability of at least part of a communication link. The apparatus is configured to receive, from a first functional safety application, a plurality of first messages for verifying availability of a communication link between the first functional safety application and a second functional safety application according to one or more parameters associated with the communication link, wherein each first message includes one or more respective data; and exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

A still further aspect of the present disclosure provides apparatus in a first network node for verifying availability of at least part of a communication link. The apparatus is configured to generate and send, to a first functional safety application, a plurality of first messages for verifying availability of a communication link between the first functional safety application and a second functional safety application according to one or more parameters associated with the communication link, each first message includes one or more respective data; and exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of at least part of a communication network;

FIG. 2 is a flow chart of an example of a method in a first network node for verifying availability of at least part of a communication link;

FIG. 3 is a flow chart of another example of a method in a first network node for verifying availability of at least part of a communication link;

FIG. 4 shows an example of communications between various nodes in a network;

FIG. 5 shows another example of at least part of a communication network;

FIG. 6 is a schematic of an example of apparatus in a first network node for verifying availability of at least part of a communication link; and

FIG. 7 is a schematic of another example of apparatus in a first network node for verifying availability of at least part of a communication link.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Functional safety applications may use a communication channel to communicate, where the communication channel is considered as a black channel. Such functional safety applications may exchange messages (e.g. watchdog messages) to verify that a communication link between two applications is available. However, this may cause substantial overhead within the communication link and the communication channel. In wireless networks in particular, e.g. in a 3GPP radio network, that overhead causes significant cost, and may also limit the number of safely applications and/or other time-sensitive applications within the network or within cells. Furthermore, the watchdog messages are sent as application-level messages over the user plane, which requires a complete L2 or L3 frame. For example, the payload of each message may be a minimum of 64 bytes per message and also per acknowledgement. The 3GPP network has no means to distinguish a watchdog message from any other message. In some examples, the network will schedule the watchdog messages with the same very high priority as any other user payload message of other control systems.

In some examples, a safety application (e.g. a safety button application) may send watchdog messages to another safety application (e.g. a safety button controller application) with a periodicity of 250 us up to 1s determined by a configured cycle time Tc. Failure to receive an acknowledgement within a predetermined time (often the same time period Tc) will cause the safety application to issue a ‘preventive trigger’, i.e. the applications go into a safe operational mode.

Under normal conditions a functional safety application should very seldomly issue an intentional trigger. For example, an emergency stop button may be pressed once in a week. As a result, the watchdog messages sent in that week may be considered unnecessary. Referring to the example above, the 120 million watchdog messages (500 Mbyte) sent in that week, plus the acknowledgements, may be considered as a waste of resources, including radio or wireless resources where at least part of the communication link between the functional safety applications is a wireless link.

Upon such a trigger (preventive or intentional) the associated system, e.g. industrial machine, may stop operation and/or enter a safe mode. Starting it again may require human interaction by default. When a safety application function intentionally triggers, e.g. an emergency button is pressed, then an emergency trigger message is sent from one functional safety application to the other application. Such messages are not considered a waste of resources.

Examples of the present disclosure may reduce or eliminate significant overhead traffic incurred by functional safety applications applying ‘black channel’ methods that use watchdog messages. In some examples, instead of transferring the watchdog messages over the network, which may be at least partially a wireless network, the network will actively supervise established communication channels by applying much smaller messages for the channel supervision. For example, the network may use short messages such as radio resource layer messages to supervise one part of the communication link between two functional safety applications, e.g. the User Equipment (UE) to Radio Access Network (RAN) part of the link, and/or short messages such as GPRS Tunneling Protocol-User Plane (GTP-U) messages for another part of the communication link, e.g. the RAN to User Plane Function (UPF) part of the link.

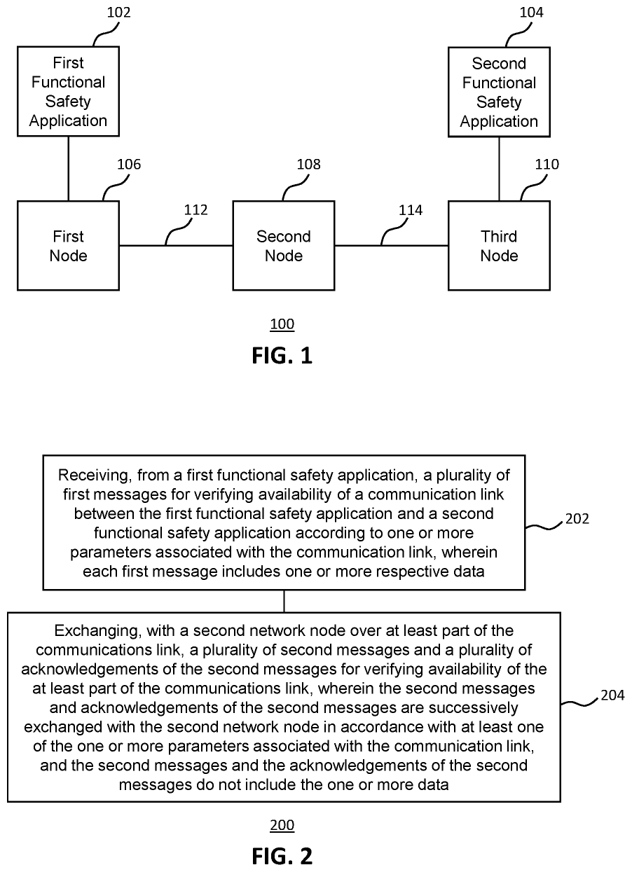

FIG. 1 shows an example of at least part of a communication network 100. The communication network includes a first functional safety application 102 and a second functional safety application 104. A communication link exists between the first and second functional safety applications. In the example shown, the communication link exists via first node 106, second node 108 and third node 110. A first part 112 of the communication link is present between the first node 106 and the second node 108, and a second part 114 of the communication link is present between second node 108 and third node 110. In some examples, the first functional safety application 104 is executing on or is in communication with the first node 106, and the second functional safety application is executing on or is in communication with the second node 110. In some examples, the first node 106 is a User Equipment (UE), the second node 108 is a base station such as an eNB or gNB, and the third node 110 is a cellular network core network node such a User Plane Function (UPF), though these are only illustrative examples. In this example, however, the first part 112 of the communication link is a wireless communication link.

FIG. 2 is a flow chart of an example of a method 200 in a first network node for verifying availability of at least part of a communication link. The first network node may be for example the first node 106 or the third node 110 shown in FIG. 1. The at least part of the communication link may therefore be in some examples the first part 112 or the second part 114 shown in FIG. 1. The method 200 comprises, in step 202, receiving, from a first functional safety application (e.g. first functional safety application 102 shown in FIG. 1), a plurality of first messages for verifying availability of a communication link between the first functional safety application and a second functional safety application (e.g. second functional safety application 104 shown in FIG. 1) according to one or more parameters associated with the communication link, wherein each first message includes one or more respective data. In some examples, the method 200 also comprises generating and sending a respective acknowledgment of each of the first messages to the first application. Thus for example the first functional safety application will receive confirmation that the communication link between the first and second functional safety applications is available.

The method 200 also comprises, in step 204, exchanging, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data. Thus, for example, the second messages may be smaller than if the second messages simply contained the first messages or included the one or more data. In some examples, therefore, the first messages are not sent over the at least part of the communication link between the first and second network nodes. The method 200 may thus comprise refraining from forwarding at least one of the plurality of first messages to the second application. In some examples, the plurality of second messages comprise a plurality of Radio Resource Control, RRC, or GPRS Tunnelling Protocol, GTP, messages, and/or the plurality of acknowledgments of the second messages comprise a plurality of Radio Resource Control, RRC, or GPRS Tunnelling Protocol, GTP, messages.

In some examples, the first functional safety application may send the first messages to the first node with the intention that they are forwarded to the second functional safety application. However, examples of this disclosure refrain from forwarding the first messages from the first network node in this manner and instead exchange second messages and their acknowledgements with the second network node. In some examples, a node associated with the second functional safety application (e.g. the third node 110 in FIG. 1) may generate first messages and send them to the second functional safety application, so that the second functional safety application does not enter a shutdown or safety mode or similar.

In some examples, the one or more parameters associated with the communication link include one or more parameters relating to communications, such as the first messages, sent over the communication link. For example, the one or more parameters may include a first frequency of successively receiving each of the first messages from the first functional safety application and/or a time period between receiving each first message from the functional safety application. In other words, the parameters may include the frequency at which the first functional safety application sends the first messages to the first network node. In some examples, the first functional safety application may send the first messages to the second functional safety application, but the first network node does not forward these messages. Instead, another node in the network (e.g. associated with the second functional safety application) may generate messages that may be identical or similar to the first messages and provide them to the second functional safety application. These generated messages may for example not be sent over at least part of the communication link (e.g. the part over which the second messages are exchanged).

Receiving the first messages from the first functional safety application in step 202 may in some examples comprise successively receiving each of the plurality of messages at substantially the first frequency or in accordance with the time period between each first message. For example, the first functional safety application may provide one first message at substantially regular intervals as defined in the parameter(s) of the communication link.

In some examples, exchanging a plurality of second messages and a plurality of acknowledgements of the second messages in step 204 of the method 200 may comprise successively receiving the plurality of second messages from the second network node substantially at the first frequency or in accordance with the time period, and sending a respective one of the acknowledgements of the second messages to the second network node in response to each of the second messages. This may be done for example at regular intervals as defined in the parameter(s) of the communication link. Alternatively, in some examples, exchanging a plurality of second messages and a plurality of acknowledgements of the second messages in step 204 may comprise successively sending the plurality of second messages to the second network node substantially at the first frequency or in accordance with the time period, and receiving a respective one of the acknowledgements of the second messages from the second network node in response to each of the second messages. The one or more parameters may in some examples include a further time period, and the method comprises, if an acknowledgement of one of the second messages is not received within the further time period after sending one of the second messages, indicating to the application that the communications link is inoperative. The first functional safety application and/or the second functional safety application may then go into a shutdown, trigger or safety mode as appropriate. For example, the first network node may at this point stop acknowledging the first messages from the first functional safety application, which may result in the appropriate action from the first functional safety application. Additionally or alternatively, the first network node may stop sending the second messages to the second network node. This may ultimately result in for example a node associated with the second functional safety application stopping generating and/or sending first messages to the second functional safety application, which may result in the appropriate action from the first functional safety application.

The one or more parameters may in some examples include a communication protocol associated with the first messages. In this case, for example, the first network node may be able to use knowledge determine information about the first messages, such as for example determining that they are first messages, determining that they are watchdog messages, and/or determining that they are being sent to the second functional safety application.

For example, the method 200 may comprise determining that the plurality of first messages are for verifying availability of the communications link between the first application and the second application. This may be done in some examples by comparing at least one field in each first message with at least one corresponding field in at least one earlier message received from the first application. In some cases, for example with certain communication protocols, one or more messages such as watchdog messages may contain the same data in one or more fields. Examples of this disclosure may thus determine that certain fields in different messages from the first functional safety application contain the same data, and conclude that these messages are watchdog messages (for example because messages other than watchdog messages are expected to form a small fraction of messages exchanged between functional safety applications). The method 200 may also in some examples comprise determining that at least one further message from the first application is not for verifying availability of the communications link between the first application and the second application, and forwarding the at least one further message to the second application. The first network node may determine that that further message is not for verifying availability of the communications link (e.g. is not a watchdog message) by determining in some examples that one or more data in the field(s) in the further message is not the same as corresponding data in one or more earlier first messages from the first functional safety application. In some examples, the at least one field in each first message contains the respective one or more data for the first message

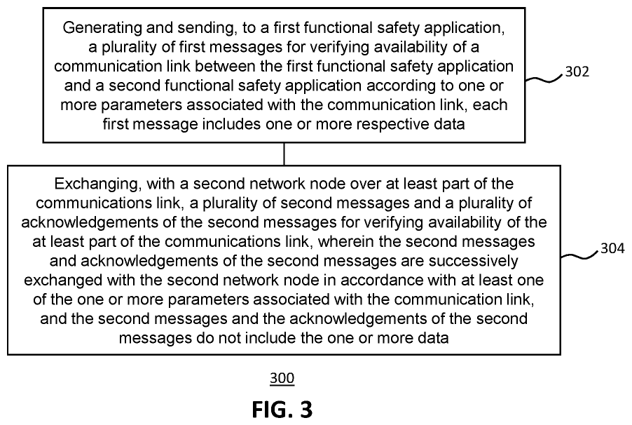

FIG. 3 is a flow chart of an example of a method 300 in a first network node for verifying availability of at least part of a communication link. The first network node may be for example the first node 106 or the third node 110 shown in FIG. 1. The at least part of the communication link may therefore be in some examples the first part 112 or the second part 114 shown in FIG. 1. The method 300 comprises, in step 302, generating and sending, to a first functional safety application, a plurality of first messages for verifying availability of a communication link between the first functional safety application and a second functional safety application according to one or more parameters associated with the communication link, each first message includes one or more respective data.

Step 304 of the method 300 comprises exchanging, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data. In some examples, step 304 of the method 300 is the same as or similar to step 204 of the method 200 described above, including where appropriate any variants of that step. Thus, in some examples, the second messages may be smaller than if the second messages simply contained the first messages or included the one or more data. In some examples, therefore, the first messages are not sent over the at least part of the communication link between the first and second network nodes. The method 300 may thus comprise refraining from forwarding at least one of the plurality of first messages to the second application. In some examples, the plurality of second messages comprise a plurality of Radio Resource Control, RRC, or GPRS Tunnelling Protocol, GTP, messages, and/or the plurality of acknowledgments of the second messages comprise a plurality of Radio Resource Control, RRC, or GPRS Tunnelling Protocol, GTP, messages.

In some examples, the method 300 further comprises, before receiving the plurality of first messages, receiving, from the first functional safety application or the second functional safety application, a request to establish the communication link between the first functional safety application and the second functional safety application, wherein the request indicates the one or more parameters associated with the communication link, and establishing the communication link between the first functional safety application and the second functional safety application. The one or more parameters may include for example a first frequency of successively sending each of the first messages from the first functional safety application and/or a time period between sending each first message from the functional safety application. In some examples, sending the first messages to the first functional safety application in step 302 may comprise successively sending each of the plurality of messages at substantially the first frequency or in accordance with the time period between each first message. For example, one message may be sent at certain time intervals as indicated by the parameter(s).

In some examples, exchanging a plurality of second messages and a plurality of acknowledgements of the second messages may comprise successively receiving the plurality of second messages from the second network node substantially at the first frequency or in accordance with the time period, and sending a respective one of the acknowledgements of the second messages to the second network node in response to each of the second messages. Alternatively, in some examples, exchanging a plurality of second messages and a plurality of acknowledgements of the second messages may comprise successively sending the plurality of second messages to the second network node substantially at the first frequency or in accordance with the time period, and receiving a respective one of the acknowledgements of the second messages from the second network node in response to each of the second messages. The one or more parameters may include a further time period. The method may thus comprise, for example, if an acknowledgement of one of the second messages is not received within the further time period after sending one of the second messages, indicating to the application that the communications link is inoperative.

In some examples, an end-to-end communication link between two functional safety applications (or their associated network nodes) may be monitored or verified. Referring to FIG. 1, for example, a communication link between the first node 106 and the third node 110 may be monitored or verified. For example, the first node 106 may perform the method 200 as described above, to verify availability of the first part 112 of the communication link (e.g. the part of the communication link between a User Equipment and a RAN node such as a base station). In addition, for example, the third node 100 may perform the method 300 as describe above, to verify availability of the second part 114 of the communication link (e.g. the part of the communication link between a core network node such as a UPF and a RAN node such as a base station). Alternatively, for example, the first node 106 may perform the method 300 and the third node 110 may perform the method 200. Thus, for example, the second node 108 may exchange a plurality of second messages and acknowledgements with the first node 106, and also exchange a plurality of second messages and acknowledgements with the third node 110. In some examples, the second node 108 may generate and send second messages to the first node 106 and receive acknowledgements from the first node, and receive second messages from the third node 110 and send acknowledgements to the third node 110. Alternatively, for example, the second node 108 may receive second messages from the first node 106 and send acknowledgements to the first node 106, and generate and send second messages to the third node 110 and receive acknowledgements from the third node 110. The second messages exchanged with the two nodes 106 and 110 and the associated acknowledgements may be the same for both first and third nodes 106 and 110 in some examples, but may be different in other examples.

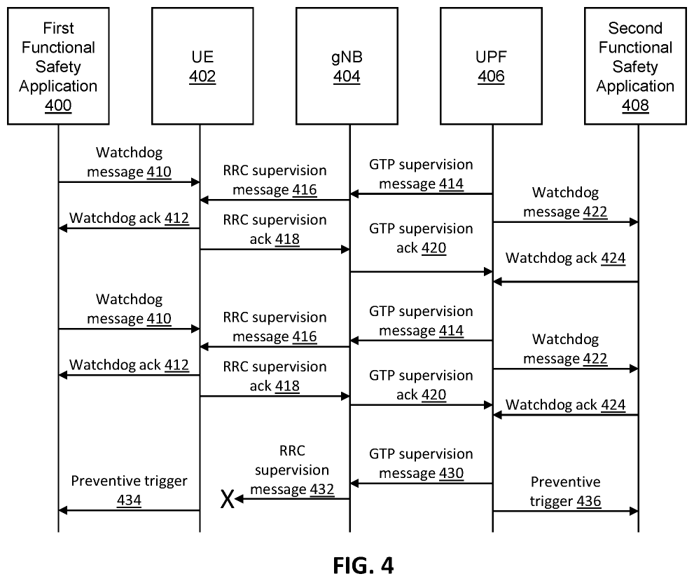

FIG. 4 shows an example of communications between various nodes in a network. In particular, FIG. 4 shows an example of communications between a first functional safety application 400, a UE 402 (an example of a first network node), a gNB 404 (an example of a second network node), a UPF 406 (another example of a first network node) and a second functional safety application 408. The first functional safety application sends a watchdog message 410 (an example of a first message) to UE 402, which receives the watchdog message 402 and sends a watchdog ack (acknowledgement) 412 to the first functional safety application 400. Thus for example the first functional safety application 400 is informed that a communication link between the first functional safety application 400 and the second functional safety application is seemingly available and operational.

The UPF sends a GTP supervision message 414 (an example of a second message) to the gNB 404. When the gNB 404 receives this message 414 it, sends RRC supervision message 416 (an example of a second message) to the UE 402. The UE 402 receives the message 416 from UPF 404, e.g. wirelessly, it replies with a RRC supervision ack 418 (an example of an acknowledgement of the second message). Once this ack 418 is received by the gNB 404, the gNB 404 sends GTP supervision ack 420 (an example of an acknowledgement of the second message) to the UPF 406 to acknowledge the GTP supervision message 414. Thus for example the parts of the communication link between the UE 402 and UPF 406 are verified as being available. In other examples, the message 416 may be sent from the UE 402 to the gNB 404, the ack 418 sent by the gNB 404 to the UE 402, the message 414 may be sent from the gNB 404 to the UPF 406, and the ack 420 sent by the UPF 406 to the gNB 404. In some such examples, the message 414 may be sent by the gNB 404 in response to receiving the message 416, and the ack 418 may be sent in response to receiving the ack 420.

The UPF sends a watchdog message 422 (an example of a first message) to the second functional safety application 408, which replies with a watchdog ack 424. Thus for example the second functional safety application 408 is informed that a communication link between the first functional safety application 400 and the second functional safety application is seemingly available and operational.

The communications 410-424 may in some examples be performed periodically, to continuously monitor the availability of the communication link and parts thereof. FIG. 4 shows each of the communications 410-424 being repeated once.

FIG. 4 also shows, at a later time, a GTP supervision message 430 being sent from the UPF 406 to gNB 404. When this message 430 is received, the gNB sends a RRC supervision message 432 being sent by gNB 404 to the UE 402. However, this message does 432 not reach the UE 402, for example due to degradation of radio conditions, hardware failure or any other reason. The UE 402 notices that an expected periodic RRC supervision message has not been received. Therefore, the UE 402 sends a preventative trigger 434 to the first functional safety application 400. This may for example cause the first functional safety application 400 to stop operation and/or enter a safe mode. In addition, in some examples, the gNB does not receive an acknowledgement of the RRC supervision message 432 from the UE 402, and hence does not send an acknowledgement of the GTP supervision message 430 to the UPF 406. The UPF may then notice that it has not received the expected ack to the GTP supervision message 430. Therefore, the UPF 406 sends a preventative trigger 436 to the second functional safety application 408. This may for example cause the second functional safety application 408 to stop operation and/or enter a safe mode.

Particular example embodiments will now be described. A functional safety application may request a communication channel with another functional safety application from a network, such as for example one that includes at least a portion that uses wireless communication. The wireless communication part may use any suitable wireless communication technology, including for example Wi-Fi, 4G (LTE) and/or 5G (New Radio). When a safety application requests a communication channel, in some examples it may have the option to request a new PDU session type. This session type is referred to herein as “Active Supervised Communication Channel” (ASCC). The functional safety application (which may for example be the first or second functional safety application described above) may also provide one or more parameters for the communication channel. These parameters may include one or more of the following:
PDU session type: ASCC,
Time period (T0),
Application protocol (e.g. Profisafe), and
Cycle time (Tc).

In some examples, the PDU session may be requested via PDU session management procedures as defined in 3GPP standards (in examples where 4G and/or 5G communication is used), as extended such that one or more of the above parameters may be specified.

The following describes an example procedure in which a communication channel at least partially including a 5G (New Radio) portion is requested. However, such examples and any examples described herein may alternatively be applied to or implemented with other communication technologies including other wireless communication technologies.

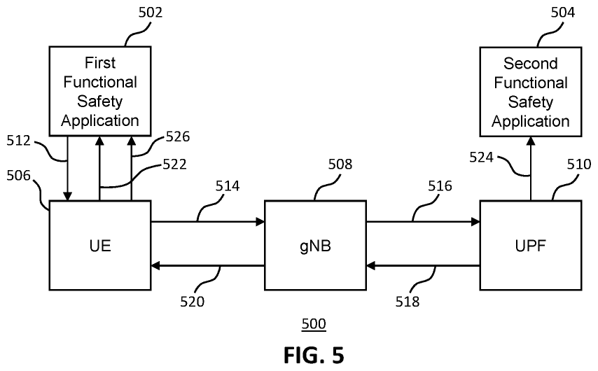

In a channel establishment phase, a 5G system (e.g. UE and UPF nodes), after establishing an ASCC when requested from a functional safety application (the ASCC being between that application and another functional safety application located elsewhere in the network), will acknowledge the establishment towards the application. FIG. 5 shows an example of at least part of a communication network 500 in which some examples may be implemented.

The communication network 500 includes a first functional safety application 502 and a second functional safety application 504. A communication link exists between the first and second functional safety applications. In the example shown, the communication link exists via UE 506, gNB 508 and UPF 510. In some examples, the communication network 500 may be a particular example of the communication network 100 of FIG. 1. For example, the UE 506 may be an example of the first node 106, the gNB 508 may be an example of the second node 108, and the UPF 510 may be an example of the third node 110.

In the example shown in FIG. 5, the first functional safety application 502 may send a communication 512 that is a request for an ASCC. The communication 512 may be sent for example to the UE 506, the gNB 508, the UPF 510, the second functional safety application 504 or any suitable network node. The request may specify for example one or more of PDU session type (ASCC), time period (T0), application protocol (e.g. Profisafe) and cycle time (Tc) as suggested above. The UE 506 sends communication 514 (which may in some examples be a forwarded communication 512) to gNB 508, specifying at least some of the same information. The gNB 508 may in turn send a communication 516 to the UPF 510 specifying the same information.

Next, the UPF 510 (for example if the requirements of the ASCC can be met) returns a communication 518 to the gNB 508 specifying confirmation of the requested ASCC type PDU session. The gNB 508 then sends a communication 520 to the UE 506 specifying confirmation of the requested ASCC type PDU session. Finally, the UE sends a communication 522 to the first functional safety application 502 specifying confirmation of the requested ASCC type PDU session. In some examples, one or more of the communications 518, 520 and 522 may indicate values for time period (T0) and/or cycle time (Tc). This may be useful for example where the requested values cannot be met by the communication network 500 but alternative values (e.g. higher values) may be met instead.

The UE, RAN and UPF nodes will start active channel supervision. As an option, the UE or UPF may for example instead indicate to the application that it can establish a ASCC but only with a different parameter T0′ and/or Tc′. This may occur for example if there are not enough network resources available to meet the initial request. Upon such an indication, the application may close or abandon the ASCC, or may accept the ASCC with the modified parameters T0′ and/or Tc′ (e.g. as indicated in communication 522 as suggested above).

As an option, the UPF or UE may for example indicate at any time after successful ASCC establishment that it can no longer maintain the service level for the ASCC. The UPF/UE may then indicate to the application a different timer T0″ and/or Tc″. Such an indication may be provided for example when network resources become insufficient to support the ASCC, e.g. due to cell changes or degraded radio conditions. Upon such an indication, the application may close or abandon the ASCC, or may accept the ASCC with the modified parameters T0″ and/or Tc″.

In an active channel supervision phase, after the ASCC is established, active channel supervision is started by the UE and RAN node (e.g. base station) as well as by the UPF node. The UPF node generates and sends a new message, e.g. a GPRS Tunneling Protocol (GTP) message referred to herein as ‘GTP supervision message,’ to the RAN node each time the timer Tc expires. The timer Tc is restarted after the message is sent. The UPF node starts timer T0 to supervise the reception of an acknowledgement message, e.g. a GTP message referred to herein as a ‘GTP supervision ack’ message, from the RAN node.

The RAN node, upon reception of the GTP supervision message, sends a new message, e.g. a Radio Resource Control (RRC) message referred to herein as a ‘RRC supervision’ message, to the UE. The UE, upon reception of the RRC supervision message, starts timer T0 and sends an acknowledgement message, e.g. a RRC message referred to herein as ‘RRC supervision ack’ message, back to the RAN node. The timer T0 in the UE is stopped (and may be restarted) when the next RRC supervision message is received from RAN. Upon reception of the RRC supervision ack message from the UE, the RAN node sends a GTP supervision ack message to the UPF. The UPF stops (and may restart) timer T0.

In some examples, after the ASCC is established, the UE may detect the first messages, e.g. application-level (e.g. Profisafe) watchdog messages, received from a first functional safety application and silently discard them. The UE may generate acknowledgement messages, e.g. application-level watchdog ack messages, and send them to the functional safety application. The UPF may send messages similar to the first messages, e.g. application-level (e.g. Profisafe) watchdog messages, with the periodicity indicated by the timer Tc to a second functional safety application and discard watchdog ack messages received from the application function in reply.

In some examples, both the UE and the UPF nodes may analyse the received messages from the functional applications and store safety protocol related status information. For example, in case of Profisafe that information is contained as an SPDU (Session Layer Protocol Data Unit) in the payload of a Profinet message identified by the Type-field of the Ethernet frame. From that SPDU the UE and UFP may extract and store the fields ‘F-Input’, ‘F-output’ and ‘Status/Control’, which may be examples of the fields referred to above, and the extracted information examples of the one or more data. When a subsequent message is received that has the same unchanged field values, that message is considered a watchdog message and may be discarded as described above. If the field values differ, the message is passed though, and the new values are stored.

In some examples, the UE and UPF may also extract and store the same fields from messages that are received from the UFP and UE, respectively, before they are sent further to the functional safety applications. When the timer Tc expires, the UPF may use these stored values to construct a watchdog message to be sent to the functional safety application as described above. The UE may use these values to construct and send a watchdog ack message to the application as described above.

A preventive trigger may in some examples be sent to the functional safety application(s) by the UE and/or UPF as appropriate when the supervision of the ASCC has failed in the 5G system. Such a failure is indicated when the timers T0 and Tc expire in the UPF or UE, without an appropriate message or ack being received. For example, when the timer T0 expires in the UPF (e.g. the GTP ack message was not received in time) it may send a message, e.g. a message referred to herein as ‘ASCC-disconnected’ notification (PDU session disconnect),’ to the functional safety application function associated with the UPF. This message is represented in FIG. 5 as communication 524 from UPF 510 to the second functional safety application 504. The UPF may also stop generating watchdog messages to send to the functional safety application. The UPF may also in some examples trigger the PDU session disconnect procedure towards the RAN node. When the timer Tc expires in the UE (e.g. no RRC supervision message was received in time) it may send a message, e.g. a message referred to herein as ‘ASCC-disconnected notification (PDU session disconnect),’ to the functional safety application associated with the UE. This message is represented in FIG. 5 as communication 526 from UE 506 to the first functional safety application 502. The UE may also in some examples trigger the PDU session disconnect procedure towards the RAN node.

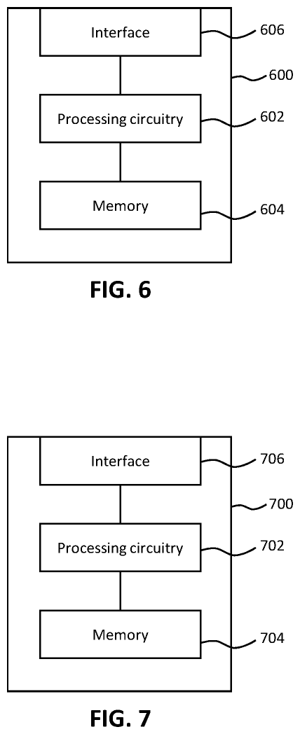

FIG. 6 is a schematic of an example of apparatus 600 in a first network node for verifying availability of at least part of a communication link. The apparatus 600 comprises processing circuitry 602 (e.g. one or more processors) and a memory 604 in communication with the processing circuitry 602. The memory 604 contains instructions executable by the processing circuitry 602. The apparatus 600 also comprises an interface 606 in communication with the processing circuitry 602. Although the interface 606, processing circuitry 602 and memory 604 are shown connected in series, these may alternatively be interconnected in any other way, for example via a bus.

In one embodiment, the memory 604 contains instructions executable by the processing circuitry 602 such that the apparatus 600 is operable to receive, from a first functional safety application, a plurality of first messages for verifying availability of a communication link between the first functional safety application and a second functional safety application according to one or more parameters associated with the communication link, wherein each first message includes one or more respective data, and exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data. In some examples, the apparatus 600 is operable to carry out the method 200 described above with reference to FIG. 2.

FIG. 7 is a schematic of an example of apparatus 700 in a first network node for verifying availability of at least part of a communication link. The apparatus 700 comprises processing circuitry 702 (e.g. one or more processors) and a memory 704 in communication with the processing circuitry 702. The memory 704 contains instructions executable by the processing circuitry 702. The apparatus 700 also comprises an interface 706 in communication with the processing circuitry 702. Although the interface 706, processing circuitry 702 and memory 704 are shown connected in series, these may alternatively be interconnected in any other way, for example via a bus.

In one embodiment, the memory 704 contains instructions executable by the processing circuitry 702 such that the apparatus 700 is operable to generate and send, to a first functional safety application, a plurality of first messages for verifying availability of a communication link between the first functional safety application and a second functional safety application according to one or more parameters associated with the communication link, each first message includes one or more respective data, and exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data. In some examples, the apparatus 700 is operable to carry out the method 300 described above with reference to FIG. 3.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-41. (canceled)

42. A method in a first network node for verifying availability of at least part of a communication link, the method comprising:
receiving, from a first functional safety application, a plurality of first messages for verifying availability of a communication link between the first functional safety application and a second functional safety application according to one or more parameters associated with the communication link, wherein each first message includes one or more respective data; and
exchanging, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

43. The method of claim 42, further comprising, before receiving the plurality of first messages:
receiving, from the first functional safety application or the second functional safety application, a request to establish the communication link between the first functional safety application and the second functional safety application, wherein the request indicates the one or more parameters associated with the communication link; and
establishing the communication link between the first functional safety application and the second functional safety application.

44. The method of claim 42, wherein the one or more parameters include a first frequency of successively receiving each of the first messages from the first functional safety application and/or a time period between receiving each first message from the functional safety application, and wherein receiving the first messages from the first functional safety application comprises successively receiving each of the plurality of messages at substantially the first frequency or in accordance with the time period between each first message.

45. The method of claim 44, wherein exchanging a plurality of second messages and a plurality of acknowledgements of the second messages comprises successively receiving the plurality of second messages from the second network node substantially at the first frequency or in accordance with the time period, and sending a respective one of the acknowledgements of the second messages to the second network node in response to each of the second messages.

46. The method of claim 44, wherein exchanging a plurality of second messages and a plurality of acknowledgements of the second messages comprises successively sending the plurality of second messages to the second network node substantially at the first frequency or in accordance with the time period, and receiving a respective one of the acknowledgements of the second messages from the second network node in response to each of the second messages.

47. The method of claim 46, wherein the one or more parameters include a further time period, and the method comprises, if an acknowledgement of one of the second messages is not received within the further time period after sending one of the second messages, indicating to the application that the communications link is inoperative.

48. The method of claim 42, wherein the one or more parameters include a communication protocol associated with the first messages.

49. The method of claim 42, comprising determining that the plurality of first messages are for verifying availability of the communications link between the first application and the second application.

50. The method of claim 49, comprising determining that each of the first messages is for verifying availability of the communications link between the first application and the second application by comparing at least one field in each first message with at least one corresponding field in at least one earlier message received from the first application, wherein the at least one field in each first message contains the respective one or more data for the first message.

51. The method of claim 49, comprising determining that at least one further message from the first application is not for verifying availability of the communications link between the first application and the second application, and forwarding the at least one further message to the second application.

52. The method of claim 42, wherein the communications link is associated with a first message time period, and wherein the first frequency is based on the first message time period.

53. A method in a first network node for verifying availability of at least part of a communication link, the method comprising:
generating and sending, to a first functional safety application, a plurality of first messages for verifying availability of a communication link between the first functional safety application and a second functional safety application according to one or more parameters associated with the communication link, each first message includes one or more respective data; and
exchanging, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

54. The method of claim 53, further comprising, before receiving the plurality of first messages:
receiving, from the first functional safety application or the second functional safety application, a request to establish the communication link between the first functional safety application and the second functional safety application, wherein the request indicates the one or more parameters associated with the communication link; and
establishing the communication link between the first functional safety application and the second functional safety application.

55. The method of claim 53, wherein the one or more parameters include a first frequency of successively sending each of the first messages from the first functional safety application and/or a time period between sending each first message from the functional safety application, wherein sending the first messages to the first functional safety application comprises successively sending each of the plurality of messages at substantially the first frequency or in accordance with the time period between each first message.

56. The method of claim 55, wherein exchanging a plurality of second messages and a plurality of acknowledgements of the second messages comprises successively receiving the plurality of second messages from the second network node substantially at the first frequency or in accordance with the time period, and sending a respective one of the acknowledgements of the second messages to the second network node in response to each of the second messages.

57. The method of claim 55, wherein exchanging a plurality of second messages and a plurality of acknowledgements of the second messages comprises successively sending the plurality of second messages to the second network node substantially at the first frequency or in accordance with the time period, and receiving a respective one of the acknowledgements of the second messages from the second network node in response to each of the second messages.

58. The method of claim 57, wherein the one or more parameters include a further time period, and the method comprises, if an acknowledgement of one of the second messages is not received within the further time period after sending one of the second messages, indicating to the application that the communications link is inoperative.

59. The method of claim 53, wherein the communications link is associated with a first message time period, and wherein the first frequency is based on the first message time period.

60. Apparatus in a first network node for verifying availability of at least part of a communication link, the apparatus comprising a processor and a memory, the memory containing instructions executable by the processor such that the apparatus is operable to:
receive, from a first functional safety application, a plurality of first messages for verifying availability of a communication link between the first functional safety application and a second functional safety application according to one or more parameters associated with the communication link, wherein each first message includes one or more respective data; and
exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.

61. Apparatus in a first network node for verifying availability of at least part of a communication link, the apparatus comprising a processor and a memory, the memory containing instructions executable by the processor such that the apparatus is operable to:
generate and send, to a first functional safety application, a plurality of first messages for verifying availability of a communication link between the first functional safety application and a second functional safety application according to one or more parameters associated with the communication link, each first message includes one or more respective data; and
exchange, with a second network node over at least part of the communications link, a plurality of second messages and a plurality of acknowledgements of the second messages for verifying availability of the at least part of the communications link, wherein the second messages and acknowledgements of the second messages are successively exchanged with the second network node in accordance with at least one of the one or more parameters associated with the communication link, and the second messages and the acknowledgements of the second messages do not include the one or more data.
